(19) United States
(12) Patent Application Publication
(10) Pub. No.: US 2026/0175554 A1
(43) Pub. Date: Jun. 25, 2026

(54) AEROGEL ATTACHMENT TECHNOLOGY

(71) Applicant: Cardinal CG Company, Eden Prairie, MN (US)

(72) Inventors: Megan E. Rose, Verona, WI (US); Reaz Ahmed Chowdhury, Middleton, WI (US); Kari B. Myli, Sauk City, WI (US)

(21) Appl. No.: 19/423,837

(22) Filed: Dec. 17, 2025

Related U.S. Application Data
(60) Provisional application No. 63/736,285, filed on Dec. 19, 2024.

(51) Int. Cl. B32B 37/00; B32B 9/04; B32B 17/06; E06B 3/67; E06B 9/24; F16L 59/02

(52) U.S. Cl. CPC B32B 37/0038; B32B 9/04; B32B 17/06; E06B 3/6715; E06B 9/24; F16L 59/028; B32B 2250/02; B32B 2255/205; B32B 2307/728; E06B 2009/2417

(57) ABSTRACT

The invention provides a method of making an article including steps of providing a solvent on a major surface of a glass sheet and positioning a face of an aerogel sheet onto the major surface of the glass sheet to create a glass-aerogel article, such that the solvent on the major surface of the glass sheet facilitates adhesion of the aerogel sheet to the glass sheet. In some cases, the glass sheet can also have a coated surface comprising a low-emissivity coating.

### RELATED APPLICATIONS

This application claims priority to U.S. Provisional Patent Application No. 63/736,285, filed Dec. 19, 2024, the contents of which are incorporated herein by reference.

### FIELD OF THE INVENTION

The present invention relates to methods of making glass-aerogel articles. Additionally, the present invention relates to glass-aerogel articles that include an aerogel sheet adhered to a glass sheet.

### BACKGROUND OF THE INVENTION

Aerogel is a known insulation material. There has been an interest in using aerogel in window applications to improve the thermal insulation properties of windows. For example, it is desirable to provide an aerogel sheet adhered to a glass sheet, which can be used in windows and other glazings. However, this has been difficult to accomplish because aerogel sheets are particularly fragile, and they tend to degrade when exposed to a wide variety of materials. Also, many materials would either damage the aerogel or do not provide adequate adhesion between the glass sheet and the aerogel sheet. Further, some adhesive materials preferably are not present inside a between-pane space of an insulating glazing unit, e.g., because they may outgas substantially.

It would be desirable to provide methods of making glass-aerogel articles by adhering an aerogel sheet to a glass sheet without degrading the aerogel sheet. In particular, it would be desirable to adhere a transparent aerogel sheet to a glass sheet without causing the transparent aerogel sheet to become opaque. It would also be desirable to provide glass-aerogel articles that include a glass sheet with a substantially transparent aerogel sheet adhered thereto. Additionally, it would be desirable to provide glass-aerogel articles that are devoid of adhesives or other materials that can cause outgassing inside a between-pane space of an insulating glazing unit.

### SUMMARY

Certain embodiments provide a method of making an article, comprising: providing a solvent on a major surface of a glass sheet, and positioning a face of an aerogel sheet onto the major surface of the glass sheet to create a glass-aerogel article, such that the solvent on the major surface of the glass sheet facilitates adhesion of the aerogel sheet to the glass sheet.

In some embodiments, an entirety of the aerogel sheet is transparent both before and after positioning the face of the aerogel sheet onto the major surface of the glass sheet to create the glass-aerogel article. In some embodiments, the aerogel sheet contacts the solvent on the major surface of the glass sheet during positioning the face of the aerogel sheet onto the major surface of the glass sheet to create the glass-aerogel article, yet said contact between the aerogel sheet and the solvent does not cause the aerogel sheet to become opaque.

The solvent may comprise a material selected from the group consisting of water, methanol, acetone, N-hexane, ethanol, and isopropyl alcohol. In some embodiments, the solvent comprises water.

The aerogel sheet may be a hydrophilic aerogel sheet. In some embodiments, the aerogel sheet is synthesized from methyl silicate 51 or TMOS.

In certain embodiments, providing the solvent comprises exposing the glass sheet to the solvent in a gaseous state such that the solvent transitions from the gaseous state to a liquid state and thereby deposits in the liquid state on the major surface of the glass sheet. Providing the solvent may comprise spraying the solvent onto the major surface of the glass sheet. In some embodiments, providing solvent on the major surface of the glass sheet creates substantially uniform coverage of solvent over the major surface of the glass sheet.

In some embodiments, the method comprises heating the glass sheet such that it is above room temperature during spraying solvent onto the major surface of the glass sheet.

In certain embodiments, the method comprises flowing gas toward the aerogel sheet during positioning the face of the aerogel sheet onto the major surface of the glass sheet to create the glass-aerogel article, thereby creating a gas pressure that facilitates the adhesion of the aerogel sheet to the glass sheet.

In some embodiments, the method comprises drying the glass-aerogel article to evaporate at least some of the solvent and to facilitate adhesion of the aerogel sheet to the glass sheet. In certain embodiments, drying the glass-aerogel article evaporates at least 90% of the solvent.

In certain embodiments, after drying, the glass-aerogel article consists essentially of the glass sheet and the aerogel sheet. After drying, the glass-aerogel article may have a haze value of less than 5%. In some embodiments, after drying, the glass-aerogel article has a visible transmission of 95% or more.

The major surface of the glass sheet may bear a low-emissivity coating comprising one or more infrared-reflective films comprising silver, such that the glass-aerogel article includes the low-emissivity coating between the glass sheet and the aerogel sheet. In certain embodiments, after drying, the glass-aerogel article has a visible transmission of 30% or more.

In some embodiments, there is neither a polymeric primer nor a ceramic primer between the glass sheet and the aerogel sheet of the glass-aerogel article.

Some embodiments provide a method of making an article, comprising: providing water on a major surface of a glass sheet, and positioning a face of a hydrophilic aerogel sheet onto the major surface of the glass sheet to create a glass-aerogel article, such that the water on the major surface of the glass sheet facilitates adhesion of the hydrophilic aerogel sheet to the glass sheet.

In certain embodiments, an entirety of the hydrophilic aerogel sheet is transparent both before and after positioning the face of the hydrophilic aerogel sheet onto the major surface of the glass sheet to create the glass-aerogel article.

In some embodiments, the hydrophilic aerogel sheet contacts water on the major surface of the glass sheet during positioning the face of the hydrophilic aerogel sheet onto the major surface of the glass sheet to create the glass-aerogel article, yet said contact between the hydrophilic aerogel sheet and the water does not cause the hydrophilic aerogel sheet to become opaque. In certain embodiments, the hydrophilic aerogel sheet is a hydrophilic silica aerogel sheet synthesized from methyl silicate 51 or TMOS.

In certain embodiments, providing water comprises exposing the major surface of the glass sheet to a high humidity environment, the high humidity environment having a relative humidity of 45% or greater. The method may comprise heating the glass sheet such that it is above room temperature during exposing the major surface of the glass sheet to the high humidity environment.

In some embodiments, providing water comprises spraying water onto the major surface of the glass sheet. Spraying water onto the major surface of the glass sheet may be performed such that the major surface of the glass sheet becomes fogged yet has no visible water droplets. In some embodiments, spraying water onto the major surface of the glass sheet is performed such that the major surface of the glass sheet becomes fogged yet has no water clusters larger than 5.88 nm. The method may comprise heating the glass sheet such that it is above room temperature during spraying water onto the major surface of the glass sheet.

In certain embodiments, providing water on the major surface of the glass sheet creates substantially uniform coverage of water over the major surface of the glass sheet.

In some embodiments, during positioning the face of the hydrophilic aerogel sheet onto the major surface of the glass sheet, there is water on the major surface of the glass sheet, such that the hydrophilic aerogel sheet contacts the water. In certain embodiments, contact between the hydrophilic aerogel sheet and the water creates substantially no increase in haze of the aerogel sheet. In some embodiments, contact between the hydrophilic aerogel sheet and the water creates substantially no decrease in thermal conductivity of the aerogel sheet.

The method may comprise flowing gas toward the hydrophilic aerogel sheet during positioning the face of the hydrophilic aerogel sheet onto the major surface of the glass sheet to create the glass-aerogel article, thereby creating a gas pressure that facilitates adhesion of the hydrophilic aerogel sheet to the glass sheet. The method may comprise drying the glass-aerogel article to evaporate at least some of the solvent and to facilitate adhesion of the hydrophilic aerogel sheet to the glass sheet.

In certain embodiments, drying the glass-aerogel article evaporates at least 90% of the water. In some embodiments, after drying, the glass-aerogel article consists essentially of the glass sheet and the aerogel sheet. After drying, the glass-aerogel article may have a haze value of less than 5%. In some embodiments, after drying, the glass-aerogel article has a visible transmission of 95% or more.

In certain embodiments, the major surface of the glass sheet bears a low-emissivity coating comprising one or more infrared-reflective films comprising silver, such that the glass-aerogel article includes the low-emissivity coating between the glass sheet and the aerogel sheet. In some embodiments, after drying, the glass-aerogel article has a visible transmission of 30% or more.

In some embodiments, there is neither a polymeric primer nor a ceramic primer between the glass sheet and the hydrophilic aerogel sheet of the glass-aerogel article.

### BRIEF DESCRIPTION OF THE DRAWINGS

FIG. 1 is a schematic, broken-away, cross-sectional side view of a glass-aerogel article having an aerogel sheet adhered to a glass sheet in accordance with certain embodiments;

FIG. 2 is a schematic, broken-away, cross-sectional side view of a glass-aerogel article having an aerogel sheet adhered to a coated glass sheet in accordance with certain embodiments;

FIG. 3 is a flow chart depicting a method of making a glass-aerogel article in accordance with certain embodiments;

FIG. 4 is a flow chart depicting a method of making a glass-aerogel article and incorporating the glass-aerogel article as part of another structure in accordance with certain embodiments;

FIG. 5 is a schematic, broken-away, cross-sectional side view of a glass sheet having a major surface bearing solvent in the form of a plurality of droplets in accordance with certain embodiments;

FIG. 6 is a schematic, broken-away, cross-sectional side view of a glass sheet having a major surface bearing solvent in the form of a liquid film in accordance with certain embodiments;

FIG. 7 is a schematic side view showing a deposition nozzle positioned relative to a glass sheet and emitting a cloud of gaseous solvent over a major surface of a glass sheet;

FIG. 8 is a schematic cross-sectional side view showing a glass sheet in a chamber containing gaseous solvent in accordance with certain embodiments;

FIG. 9 is a schematic, broken-away, cross-sectional side view of an aerogel sheet and a glass sheet having therebetween solvent in the form of a plurality of droplets in accordance with certain embodiments;

FIG. 10 is a schematic, broken-away, cross-sectional side view of an aerogel sheet and a glass sheet having therebetween solvent in the form of a liquid film in accordance with certain embodiments;

FIG. 11 shows schematic, broken-away, cross-sectional side views of a glass-aerogel article before and after room temperature drying in accordance with certain embodiments;

FIG. 12 shows schematic, broken-away, cross-sectional side views of a glass-aerogel article before, during, and after drying in a furnace in accordance with certain embodiments;

FIG. 13 is a schematic, partially broken-away, cross-sectional side view of an insulating glazing unit that includes a glass-aerogel article in accordance with certain embodiments;

FIG. 14 is a schematic, partially broken-away, cross-sectional side view of another insulating glazing unit that includes a glass-aerogel article in accordance with certain embodiments;

FIG. 15 is a schematic, partially broken-away, cross-sectional side view of a laminated glass assembly that includes a glass-aerogel article in accordance with certain embodiments; and

FIG. 16 is a schematic, partially broken-away, cross-sectional side view of a laminated glass assembly that includes a glass-aerogel article in accordance with certain embodiments.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

Applicant has developed methods of making a glass-aerogel article that uses a solvent to facilitate adhesion between an aerogel sheet and a glass sheet without degrading the aerogel sheet and causing it to turn opaque. Applicant has also developed glass-aerogel articles that include an aerogel sheet adhered to a glass sheet. Applicant has also developed glass-aerogel articles that can be exposed to a between-pane space of an insulating glazing unit with little or no outgassing.

As used herein, the term “aerogel” refers to a material obtained by combining either a nonfluid colloidal network or a polymer network with a liquid so as to form a gel, and then removing the liquid from the gel and replacing the liquid with a gas or vacuum. In the present embodiments, the aerogel is provided in the form of an aerogel sheet. This is in contrast to aerogel in flowable granular or otherwise particulate form. The aerogel sheet is preferably self-supporting, i.e., once fully synthesized and formed, the sheet can retain sheet form without being adhered to glass or another support.

In the present specification, anywhere the terms “comprising” or “comprises” are used, those terms have their ordinary, open-ended meaning. In addition, where appropriate, the disclosure at each such location is to be understood to also disclose that it may, as an alternative, “consist essentially of” or “consist of”

It has been desired to provide a material that can be used to facilitate adhesion between a glass sheet and an aerogel sheet, without degrading the aerogel sheet and causing it to turn opaque. Many materials may chemically react with functional groups on an aerogel sheet. In some cases, the chemical reaction is immediate, and the materials degrade the aerogel sheet at the moment of contact. In other cases, the chemical reaction takes place over time. For example, certain materials may not degrade the aerogel sheet upon contact, yet may cause degradation over time. Other materials may physically damage the aerogel skeleton upon being absorbed by pores. It has been observed that when some materials become absorbed by the pores, either immediately or over a period of time, the pores collapse, thereby resulting in a degraded aerogel sheet.

Applicant has surprisingly discovered that solvent can be used to facilitate adhesion between a glass sheet and an aerogel sheet. A solvent can first be deposited on a glass sheet. The aerogel sheet is then positioned onto the glass sheet (this may involve moving the aerogel sheet toward the glass sheet, moving the glass sheet toward the aerogel sheet, or moving both toward each other), with the solvent in between, to form a glass-aerogel article. The solvent facilitates adhesion of the aerogel sheet to the glass sheet. The glass-aerogel article can also undergo drying, thereby causing at least some of the solvent to evaporate. As the solvent evaporates, the aerogel sheet surprisingly remains adhered to the glass sheet.

Applicant also discovered that a “sweet spot” amount of solvent can be used to facilitate the desired adhesion while also not causing substantial degradation of the aerogel sheet. Some types of aerogel sheets degrade upon contact with too much solvent, such as water. As an example, hydrophilic aerogel sheets can degrade and become opaque upon contact with too much water. However, Applicant has discovered that when a “sweet spot” amount of solvent is used, the solvent contacts the aerogel sheet without causing it to become opaque. Additionally, with this “sweet spot,” the solvent contacts the aerogel sheet without causing substantial pore collapse, substantial increase in haze, and/or substantial decrease in thermal conductivity of the aerogel sheet.

Without being bound to a particular scientific explanation, it is surmised that liquid solvent present at the interface between the glass sheet and the aerogel sheet is drawn into the aerogel pores by capillary action, thereby creating capillary pressure that facilitates some adhesion of the aerogel sheet to the glass sheet. Then, upon drying, the solvent transitions from a liquid state to a gaseous state, and negative pressure, a vacuum and/or suction is created at the interface. Additionally, it is surmised that when a “sweet spot” amount of solvent is used, enough solvent molecules are present to create capillary pressure needed for adhesion, but not so many that substantial degradation of the aerogel skeleton occurs. When this “sweet spot” is present, it is believed that cohesive forces hold the solvent molecules together and prevent them from binding to the aerogel skeleton.

Applicant has also developed methods of depositing the solvent on a glass sheet so that a “sweet spot” amount is provided. In many cases, the methods involve depositing solvent onto the glass sheet such that the solvent is not visible to the naked eye when positioning the aerogel sheet in contact with the glass sheet. Also, in many cases, the methods involve positioning the aerogel sheet onto the glass sheet, with the solvent in between, before the solvent substantially evaporates. Exemplary methods will be described in more detail herein.

The solvent can be any solvent that is capable of evaporating to facilitate adhesion between a glass sheet and an aerogel sheet, without substantially degrading the aerogel sheet. In some cases, the solvent is selected from water, methanol, acetone, N-hexane, ethanol, and isopropyl alcohol. In certain cases, the aerogel sheet is a silica aerogel sheet and the solvent is selected from water, methanol, acetone, N-hexane, ethanol, and isopropyl alcohol. In some specific, non-limiting examples, the aerogel sheet is a hydrophilic silica aerogel sheet and the solvent is water.

Applicant has found that excellent results can be obtained when water is used as the solvent. For example, water evaporates from a liquid state to a gaseous state. Also, water is non-toxic, non-flammable and easy to work with in an industrial setting. Further, water does not cause the types of substantial outgassing that is seen with certain materials, such as certain polymer adhesives and primers. Finally, in cases where the aerogel sheet is hydrophilic (e.g., hydrophilic silica aerogel), water can provide excellent results when it is deposited in a “sweet spot” amount, and it does not cause the hydrophilic aerogel sheet to become opaque.

In many embodiments, the methods described herein are used with a silica aerogel sheet. In certain embodiments, the methods are used with a silica aerogel sheet synthesized from methyl silicate (MS-51). For example, the silica aerogel sheet can be a hydrophilic silica aerogel sheet synthesized from MS-51, methanol, water and ammonia hydroxide.

In other embodiments, the methods are used with a silica aerogel sheet synthesized from tetramethyl orthosilicate (TMOS). For example, the silica aerogel sheet can be a hydrophilic silica aerogel sheet synthesized from TMOS, methanol, water and ammonia hydroxide.

Suitable silica aerogel sheets synthesized from these components are described in U.S. Patent Application Publication No. US2023/0416099, entitled “Silica Wet Gel and Aerogel Materials,” and U.S. patent application Ser. No. 18/636,553, entitled “Hydrophilic Silica Wet Gel and Aerogel,” the teachings of each which are incorporated herein by reference.

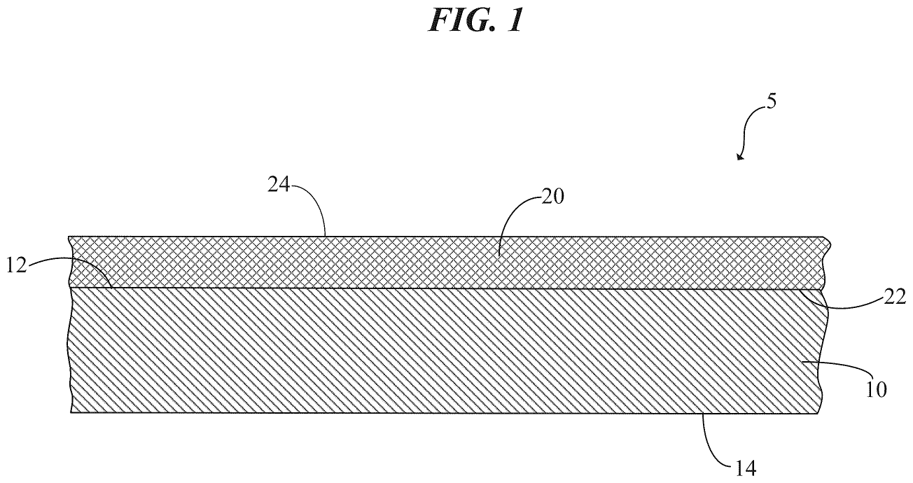

FIG. 1 illustrates a glass-aerogel article 5 that can be formed by the present methods. The glass-aerogel article 5 includes a glass sheet 10 with an aerogel sheet 20 adhered thereto. In the illustrated embodiment, the glass sheet 10 has a major surface 12 and an opposing major surface 14. The aerogel sheet 20 has a face 22 and an opposing face 24. The face 22 of the aerogel sheet 20 is adhered to (optionally directly, e.g., with nothing in between) the major surface 12 of the glass sheet 10.

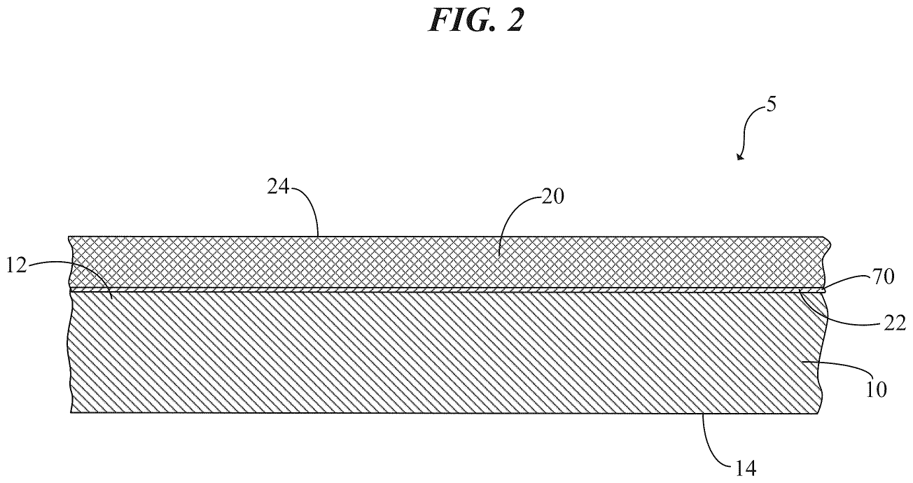

FIG. 2 illustrates another embodiment of a glass-aerogel article 5 that can be formed by the present methods. In FIG. 2, a low-emissivity coating 70 is provided on the major surface 12 of the glass sheet 10. In this embodiment, the major surface 12 of the glass sheet 10 is a coated major surface to which the face 22 of the aerogel sheet 20 is adhered. The low-emissivity coating 70 is between the glass sheet 10 and the aerogel sheet 20. In many cases, the low-emissivity coating 70 includes one or more infrared-reflective films that comprise silver.

A variety of known glass types can be used for the glass sheet 10, including soda-lime glass, borosilicate glass or aluminosilicate glass. In some cases, it may be desirable to use “white glass,” a low iron glass, etc. For some applications, it may be desirable to use tinted glass for the glass sheet 10. Moreover, there may be applications where the glass sheet 10 is formed of extremely thin, flexible glass, such as glass sold under the trademark Willow glass by Corning Inc. (Corning, New York, U.S.A.). If desired, the glass sheet 10 may be formed of a chemically strengthened glass, such as glass sold under the trademark Gorilla glass by Corning Inc. In alternative embodiments, the glass sheet 10 is replaced with a sheet formed of a polymer, such as polycarbonate, acrylic, or PVC. Various other polymer materials (e.g., transparent polymers) may be used in such alternative embodiments.

Glass sheets of various sizes can be used for the glass sheet 10. Commonly, large-area glass sheets are used. For example, the glass sheet 10 can have a major dimension (e.g., a length or width) of at least 0.1 meter, preferably at least 0.5 meter, more preferably at least 1 meter, perhaps more preferably at least 1.5 meters (e.g., from 2 meters to 4 meters), and in some cases at least 3 meters.

Glass sheets of various thicknesses can be used. In some embodiments, the glass sheet 10 can have a thickness of from 1 mm to 8 mm. In some cases, the glass sheet 10 has a thickness of from 2.3 mm to 4.8 mm, and perhaps more preferably from 2.5 mm to 4.8 mm. In one particular embodiment, the glass sheet 10 has a thickness of about 3 mm.

The aerogel sheet 20 can be of any desired type, such as those described herein. The aerogel sheet 20 can also have a desired size. In certain cases, the aerogel sheet 20 has a major dimension (e.g., a length or width) of at least 0.3 meter, for example at 0.35 meter, 0.375 meter, 0.5 meter, 0.70 meter, 0.75 meter, 0.80 meter, 0.85 meter, 0.90 meter, 0.95 meter, 1.0 meter, or in some cases at least 1.125 meters or 1.25 meters. In certain embodiments, the aerogel sheet 20 has a major dimension of from 0.7 meter to 3 meters (e.g., from 1.5 meters to 3 meters). For any embodiment of the present disclosure, the aerogel sheet 20 can optionally have a major dimension in any of these noted ranges.

In embodiments where the glass sheet 10 is a coated glass sheet bearing a low-emissivity coating 70, such as the embodiment shown in FIG. 2, the low-emissivity coating 70 preferably includes at least one silver-inclusive film, which desirably contains more than 50% silver by weight (e.g., a metallic silver film). In some cases, the low-emissivity coating 70 includes three or more infrared-reflective films (e.g., silver-containing films). Low-emissivity coatings having three or more infrared-reflective films are described in U.S. application Ser. No. 11/546,152 and U.S. Pat. Nos. 7,572,511 and 7,572,510 and 7,572,509 and Ser. No. 11/545,211 and U.S. Pat. Nos. 7,342,716 and 7,339,728, the teachings of each of which are incorporated herein by reference. In certain cases, the low-emissivity coating 70 includes four silver layers. In other cases, the low-emissivity coating can be a “single silver” or “double silver” low-emissivity coating, which are well-known to skilled artisans. Advantageous coatings of this nature are commercially available from, for example, Cardinal CG Company (Eden Prairie, Minnesota, U.S.A.).

The aerogel sheet 20 can also have a desired thickness. In some cases, the aerogel sheet 20 has a thickness in a range of from 1.5 mm to 15 mm, such from 2 mm to 8 mm, or from 2 mm to 4 mm (e.g., 3 mm or 3.5 mm). For any embodiment of the present disclosure, the aerogel sheet 20 can optionally have a thickness in any of these noted ranges, preferably in combination with having a major dimension in any of the ranges noted previously. It is to be appreciated, however, that other thicknesses can be used.

While the present specification focuses on methods of forming a glass-aerogel article 5 that includes a glass sheet 10, these methods can also be used with substrates other than glass. In some cases, a non-porous substrate can be used. In certain cases, a metallic substrate, e.g., an aluminum substrate, can be used.

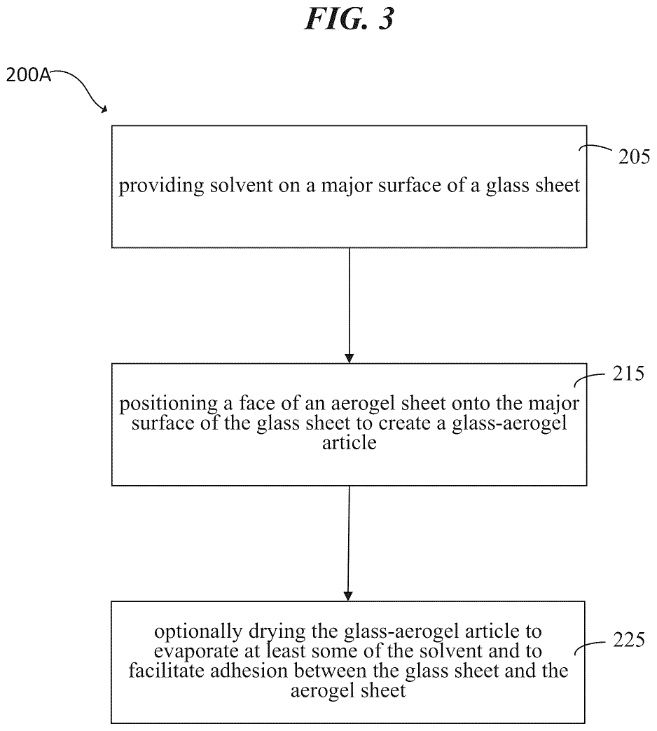

FIG. 3 illustrates an embodiment of a method 200A of making a glass-aerogel article 5. The method includes a step 205 of providing solvent on a major surface 12 of a glass sheet 10, and a step 215 of positioning a face 22 of an aerogel sheet 20 onto the major surface 12 of the glass sheet 10 to create a glass-aerogel article 5. The step 215 may involve moving the aerogel sheet 20 towards the glass sheet 10, moving the glass sheet 10 toward the aerogel sheet 20, or moving both toward each other. The solvent facilitates adhesion of the aerogel sheet 20 to the glass sheet 10. The method can also include an optional step 225 of drying the glass-aerogel article 5 to evaporate at least some of the solvent. The term “evaporate” is used herein to refer to any material (not just water) transitioning from liquid state to gaseous state.

In the step 205, the solvent is deposited so that a “sweet spot” amount of solvent is provided on the major surface 12 of the glass sheet 10. Again, it is surmised that when a “sweet spot” amount of solvent is deposited, there will be enough solvent to facilitate adhesion of the aerogel sheet 20 to the glass sheet 10, but not so much solvent as to cause substantial degradation of the aerogel sheet 20. Preferably, an entirety of the aerogel sheet 20 is transparent both before and after the positioning step 215. Thus, the aerogel sheet 20 preferably does not become opaque upon contacting the solvent. Even more preferably, contact between the aerogel sheet 20 and the solvent (1) creates substantially no pore collapse, (2) creates substantially no increase in haze and/or (3) creates substantially no decrease in thermal conductivity of the aerogel sheet 20.

Additional steps can be performed before or after the illustrated steps. For example, in one embodiment, the method 200A also includes a step of cleaning a major surface 12 of a glass sheet 10 before the step 205 of providing solvent thereon. Any glass cleaning step known in the art can be used. Additionally or alternatively, the method 200A can optionally include a step of plasma treating the major surface 12 of the glass sheet 10 before the step 205 of providing solvent thereon. In some cases, plasma treatment is performed after a cleaning step and before the step 205.

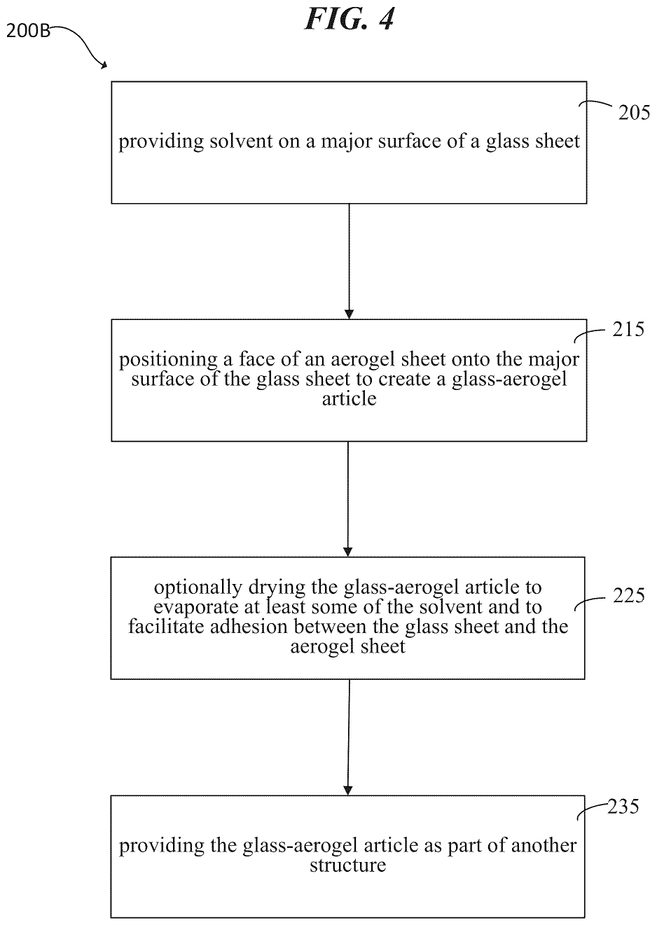

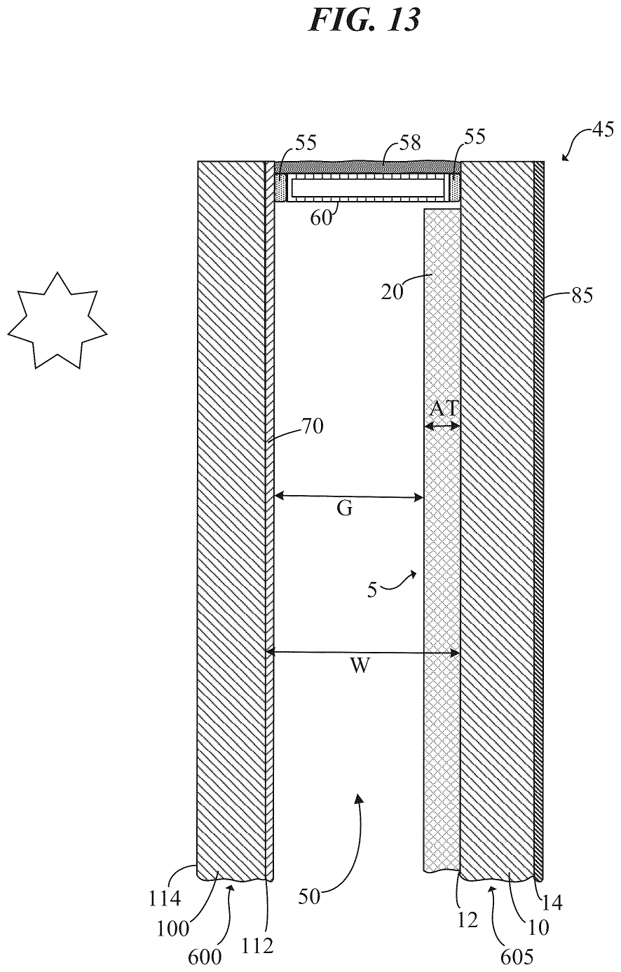

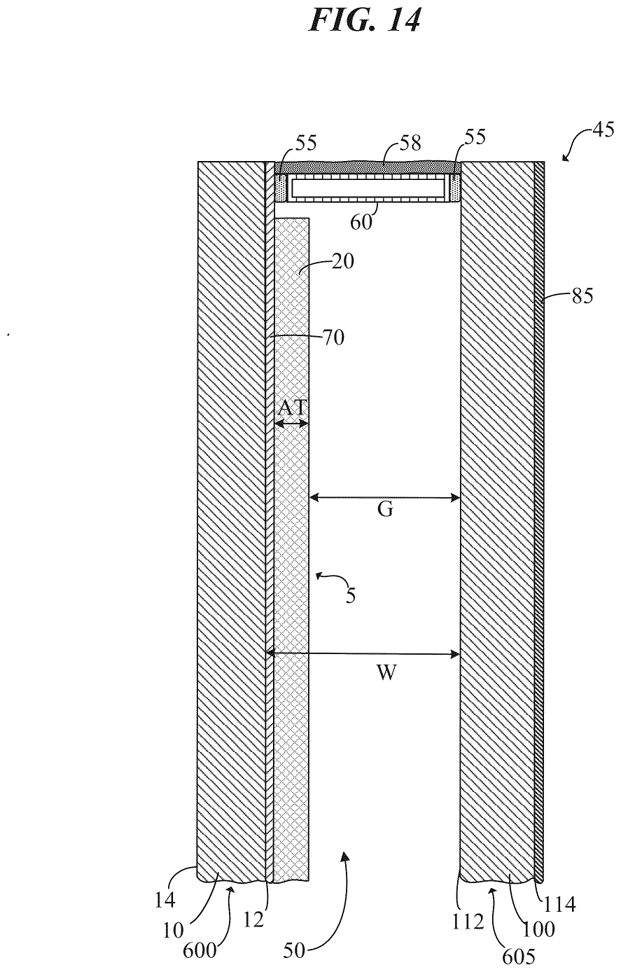

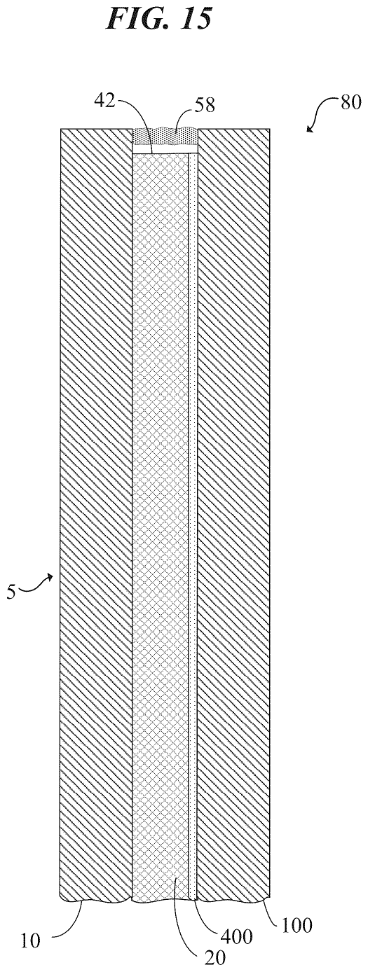

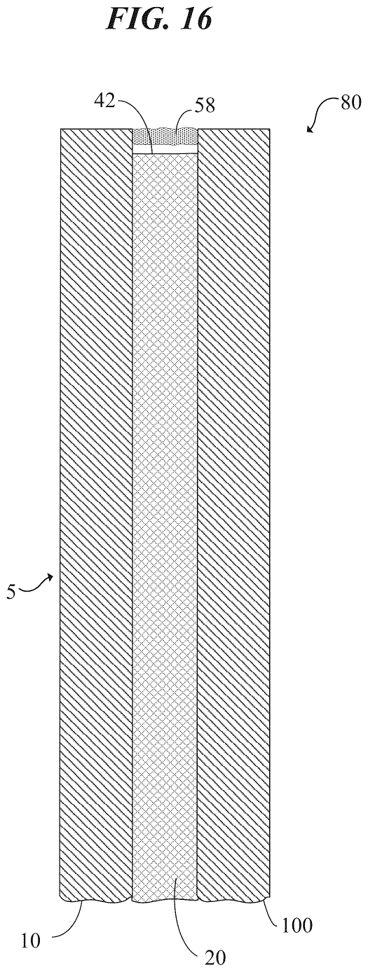

FIG. 4 illustrates a method 200B that includes the steps of method 200A and further includes a step 235 of providing the glass-aerogel article 5 as part of another structure. In some cases, the step 235 includes providing the glass-aerogel article 5 as part of (e.g., assembling it into) an insulating glazing unit 45. Two non-limiting insulating glazing unit examples are shown in FIGS. 13 and 14. In other cases, the step 235 can include providing the glass-aerogel article 5 as part of (e.g., assembling it into) a laminated glazing assembly 80. Examples of such laminated glazing assembly 80 are shown in FIGS. 15 and 16.

In step 205, solvent is provided on a major surface 12 of a glass sheet 10. In some cases, the major surface 12 of a glass sheet 10 is uncoated. However, in other cases, the major surface 12 is a coated major surface that bears a low-emissivity coating. The following deposition methods are described in reference to depositing solvent onto an uncoated major surface 12 of a glass sheet 10. However, these methods can also be used to deposit solvent on a coated major surface that bears a low-emissivity coating.

The solvent can be deposited using a deposition method that provides a “sweet spot” amount of solvent. In some cases, the solvent is deposited onto the major surface 12 such that the solvent is not visible to the naked eye when performing the positioning step 215. In certain cases, the solvent is water, and the water is deposited onto the major surface 12 such that it is not visible to the naked eye when performing the positioning step 215. In specific cases, the water is deposited so that the major surface 12 becomes temporarily fogged before performing the positioning step 215. Preferably, the major surface 12 becomes temporarily fogged uniformly across the major surface 12, but this is not required. In such cases, the positioning step 215 preferably is performed after the fogging takes place and is no longer visible, but before substantial (or complete) evaporation of the water takes place.

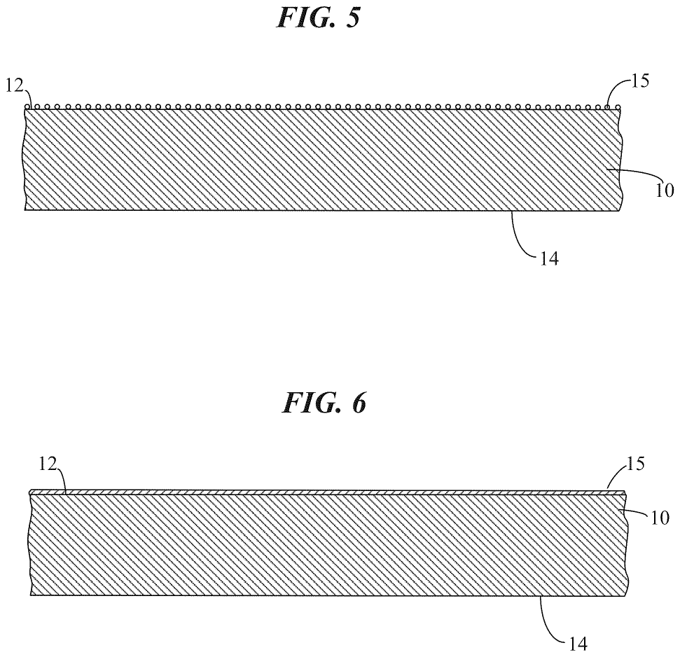

In some cases, the solvent 15 is deposited in the form of a plurality of droplets. FIG. 5 illustrates solvent 15 on a major surface 12 of the glass sheet 10 in the form of a plurality of droplets. The plurality of droplets can be deposited to have a desired droplet size. The droplets preferably have a very small size. In specific cases, the water droplets have a size of 5.88 nm or less. In FIG. 5, the plurality droplets all have substantially the same size. However, the plurality of droplets can instead have substantially different sizes, or they can all be within a desired size range, e.g., a range of 5.88 nm or less. Additionally, while FIG. 5 illustrates the droplets as being evenly spaced apart, this is not required. In certain cases, the solvent is water and is deposited as a plurality of droplets that causes the major surface 12 to temporarily appear fogged immediately after deposition. However, the fogging and water droplets preferably are not visible to the naked eye when positioning the aerogel sheet 20 in contact with the major surface 12.

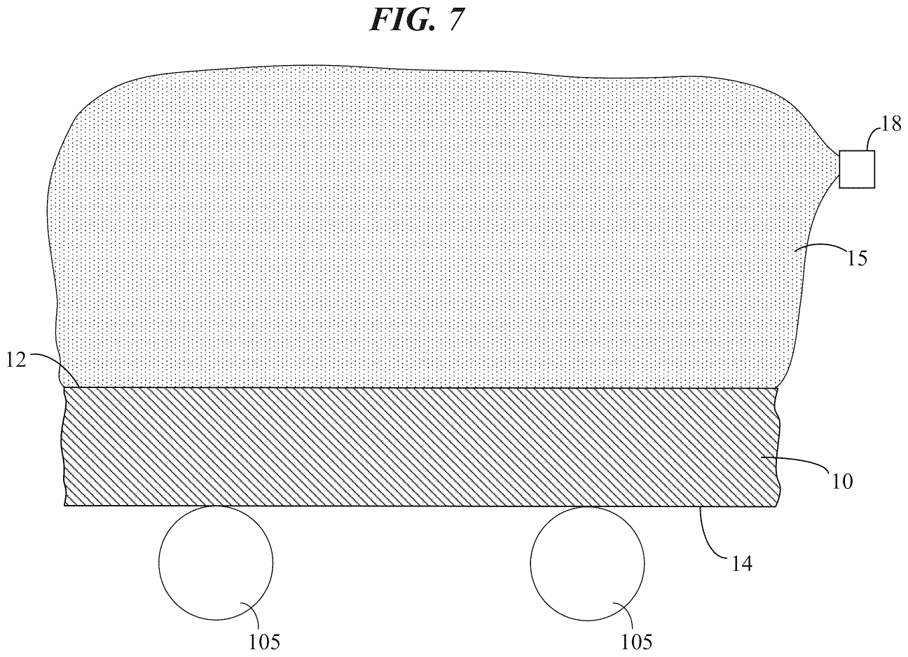

In other cases, the solvent 15 is deposited in the form of a liquid film. FIG. 6 illustrates solvent 15 on a major surface 12 of the glass sheet 10 in the form of a liquid film. When provided, the liquid film can optionally be deposited to have a desired film thickness or be within a desired thickness range. Also, while FIG. 6 illustrates the liquid film as being continuous across the major surface 12, this is not required. The liquid film can have some gaps and/or droplets mixed in. In certain cases, the solvent is water and after deposition, forms a liquid film that causes the major surface 12 to temporarily appear fogged immediately after deposition. The positioning of the aerogel sheet 20 in contact with the major surface 12 preferably is performed once the fogging and water film are not visible to the naked eye.

Also, in some cases, solvent 15 is deposited such that it provides substantially uniform coverage across the major surface 12 of the glass sheet 10. FIG. 5 shows a plurality of droplets that provides substantially uniform coverage of droplets across the major surface 12. Also, FIG. 6 shows a liquid film that provides substantially uniform coverage of film across the major surface 12. The liquid film does not need to be continuous, but preferably spans an entirety of the major surface 12. In some cases, the liquid film may be continuous over the entire major surface 12.

A variety of different deposition methods can be used to provide solvent 15 in the configurations shown in FIGS. 5-6, or in other desired configurations. In some embodiments, the solvent 15 is deposited by exposing the glass sheet 10 to the solvent 15 in a gaseous state. The solvent 15 then transitions from the gaseous state to a liquid state that deposits in the liquid state on the major surface 12. In other embodiments, the solvent 15 is deposited by spraying a solvent mist that deposits in the liquid state on the major surface 12. When the solvent deposits on the major surface 12, it preferably does not form any droplets or clusters having a size of greater than 5.88 nm. Additionally, the solvent preferably is not visible to the naked eye when the aerogel sheet 20 is positioned in contact with the major surface 12.

In some embodiments, the solvent 15 can be deposited by spraying. A spraying method can be used (e.g., controlled) to spray a solvent mist. FIG. 7 shows a deposition nozzle 18 that sprays a solvent mist 15 above a major surface 12 of a glass sheet 10, which can optionally be moving over transport rollers 105. The deposition nozzle 18 can be part of any desired deposition apparatus and can spray solvent mist 15. In some cases, as shown, the solvent mist 15 can be in the form of a solvent cloud.

The deposition nozzle 18 can be either a stationary nozzle that remains fixed relative to the glass sheet 10, or it can be a movable nozzle that moves relative to the glass sheet 10. While FIG. 7 illustrates a single deposition nozzle 18, skilled artisans will understand that a plurality of deposition nozzles can also be used. For example, the method can optionally involve conveying the glass sheet beneath a plurality of nozzles while spraying solvent from the nozzles so as to expose an entire width of the major surface of the glass sheet to the solvent mist 15. If desired, the plurality of nozzles can be on an elongated pipe, bar, or housing that is arranged above and crosswise to the path of substrate travel. In some cases, whether one nozzle or a plurality of nozzles are used, the nozzle(s) are aimed in a direction other than directly at the glass sheet. Reference is made to the non-limiting example of FIG. 7. Here, one or more nozzles are oriented to spray mist in a lateral direction above the glass sheet 10.

In some cases, the spraying process is an air spraying process that uses compressed air to form a solvent mist 15. In such cases, a compressed air line can be connected to the deposition nozzle 18, where solvent is mixed with compressed air to form a solvent mist 15 and then sprayed. The pressure of the compressed air, the solvent flow rate through the deposition nozzle 18, and/or spraying time can be adjusted to spray a solvent mist 15 having a desired droplet size, e.g., a size of 5.88 nm or less when the solvent is water. For example, as air pressure increases, the droplet size decreases. Also, as the water flow decreases, the droplet size decreases. The spraying can be performed, as desired, to deposit solvent droplet coverage and/or continuous solvent film coverage.

In other cases, the spraying process is an ultrasonic spraying process that uses ultrasonic vibrations to form a solvent mist 15. In some cases, the deposition nozzle 18 can have an ultrasonic transducer or other component that vibrates at ultrasonic frequencies to form the solvent mist 15. The ultrasonic frequency, the solvent flow rate through the deposition nozzle 18, and/or spraying time can be adjusted to spray a solvent mist 15 having a desired droplet size, e.g., a size of 5.88 nm or less when the solvent is water. As ultrasonic frequency increases, the droplet size decreases. Also, as the water flow decreases, the droplet size decreases.

In yet other cases, the spraying process is an electrostatic spraying process. In an electrostatic spraying process, a solvent mist is formed, for example by using compressed air, and then is provided with an electrostatic charge. In some cases, the deposition nozzle 18 receives a voltage, which provides a positive or negative electrostatic charge to the solvent mist 15. The major surface 12 of the glass sheet 10 is also provided with an electrostatic charge that is opposite to the electrostatic charge of the solvent mist 15. This creates an electrostatic field between the solvent mist 15 and the major surface 12, so the charged solvent mist 15 is attracted to the oppositely charged major surface 12 during spraying.

In one group of embodiments, the glass sheet 10 is exposed to solvent 15 in a gaseous state such that the solvent transitions from the gaseous state to a liquid state and thereby deposits in the liquid state on the major surface 12. In many cases, the solvent is water, and the glass sheet 10 is exposed to water vapor in a high humidity environment. The water vapor produces condensation on the major surface 12 of the glass sheet 10. In many cases, the condensation is temporarily visible as fogging.

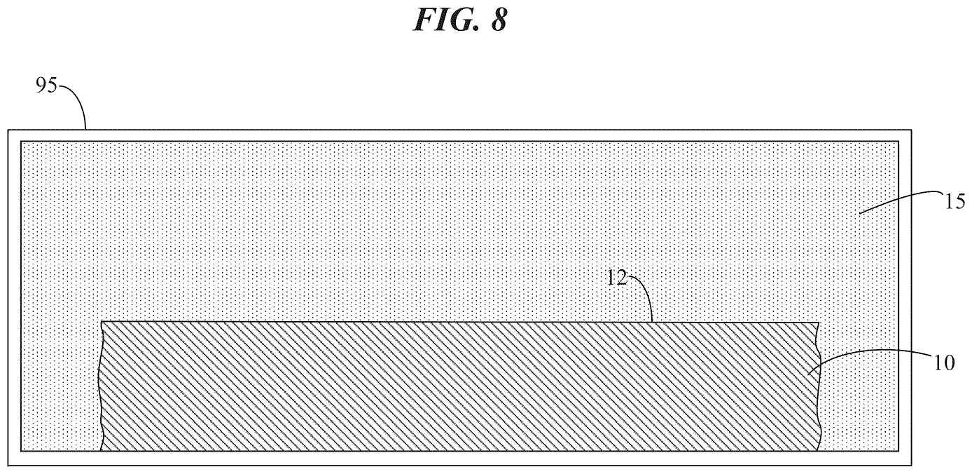

In some cases, the glass sheet 10 is placed inside a chamber that includes solvent 15 in the gaseous state. FIG. 8 illustrates a chamber 95 with a glass sheet 10 inside. The chamber 95 can be any chamber that has a solvent vapor environment. Additionally, the glass sheet 10 can be removed from the chamber 95 after a selected time period so a “sweet spot” amount of solvent is deposited onto the major surface 12.

In some cases, the chamber 95 is a humidity chamber that has a water vapor environment. For example, the humidity chamber 95 can have relative humidity levels ranging from greater than 0% to up to 100%. The relative humidity level is selected to cause water to condense on the major surface 12. In general, higher relative humidity levels will deposit more water on the major surface 12, whereas lower relative humidity levels will deposit less. In preferred cases, the relative humidity level is 45% or greater. In certain cases, the glass sheet 10 is removed from the chamber 95 after a time period of from 3 to 6 minutes so that a “sweet spot” amount of water is deposited. In further cases, the humidity chamber 95 can be a heated humidity chamber, and the glass sheet 10 can be heated to a temperature above room temperature while inside.

In some embodiments, the glass sheet 10 is heated to a temperature above room temperature before and/or during a deposition process. Applicant has found that a heated glass sheet 10 can improve deposition of solvent thereon. Thus, in some cases, the glass sheet 10 has a temperature above room temperature during spraying of solvent mist thereon. In other cases, the glass sheet 10 has a temperature above room temperature during exposure to solvent in a gaseous state.

In some cases, pressure can be applied to the aerogel sheet 20 during positioning of the aerogel sheet 20 to the glass sheet 10. The pressure can be of any type that forces the aerogel sheet 20 closer to, and/or presses against, the glass sheet 10 to help facilitate adhesion while also not damaging the aerogel sheet 20. In certain cases, pressurized gas can be flowed toward the aerogel sheet 20 during positioning. In some cases, the pressurized gas flow is a pressurized air flow. The pressurized gas flow can be applied to specific locations along the aerogel sheet 20 or applied uniformly across the entire face 24 of the aerogel sheet 20. In some cases, the pressurized gas flow is applied to the face 24 at different locations while maintaining a desired angle, e.g., an angle of about 90 degrees, between a flow nozzle and face 24. Additionally, the pressure and airflow can be adjusted to obtain optimal results.

Once the solvent 15 is provided on a major surface 12 of a glass sheet 10, the aerogel sheet 20 is positioned in contact with the glass sheet 10 to form the glass-aerogel article 5. In particular, the face 22 of the aerogel sheet 20 can be placed in contact with the major surface 12, with the solvent 15 therebetween. The solvent therefore directly contacts the aerogel sheet 20.

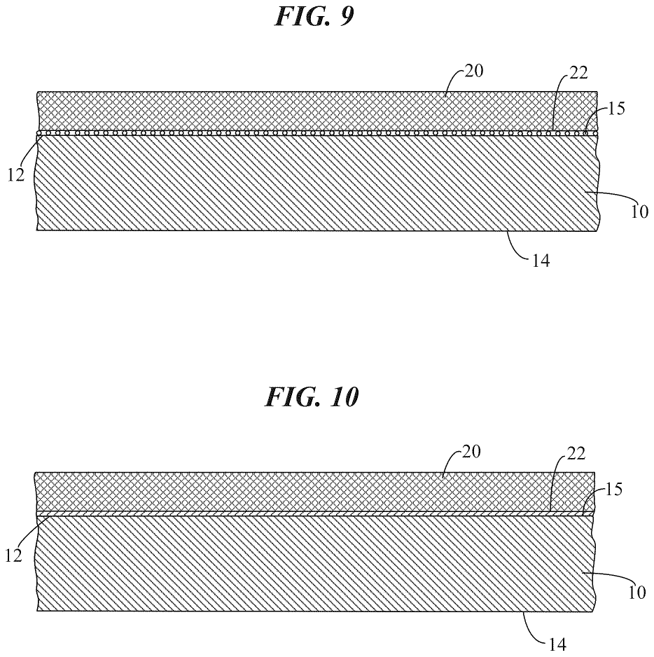

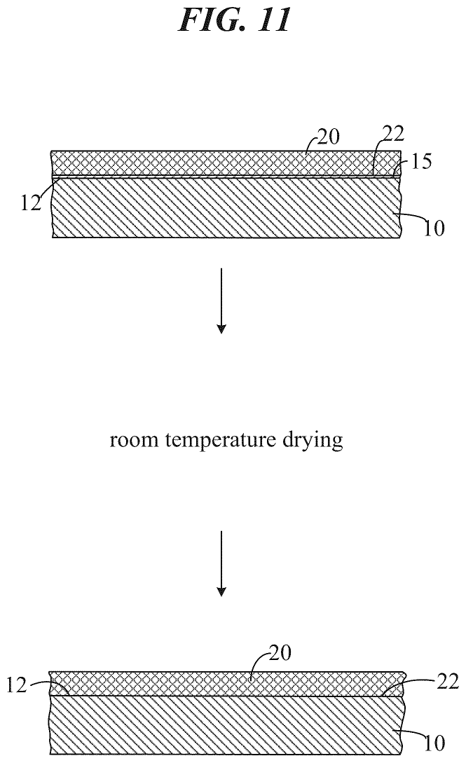

The solvent 15 then is preferably in contact with both the major surface 12 and the face 22. For example, FIG. 9 schematically illustrates the solvent 15 in the form of a plurality of droplets, the droplets being in contact with both the major surface 12 and the face 22. Similarly, FIG. 10 schematically illustrates the solvent 15 in the form of a liquid film, the liquid film being in contact with both the major surface 12 and the face 22. It is to be appreciated that the solvent may move into pores of the aerogel sheet 20 (e.g., by capillary action or another mechanism) during this process.

The solvent 15 is one that is capable of changing from a liquid state to a gaseous state and therefore will experience evaporation over a period of time. In some embodiments, the aerogel sheet 20 is positioned in contact with the glass sheet 10 within a selected time period (e.g., promptly) after providing solvent on the major surface 12 of the glass sheet. The time period preferably is selected such that the solvent does not evaporate entirely (e.g., does not experience substantial evaporation) before the positioning takes place. Different solvents have different evaporation rates and the time period can be selected accordingly. In some cases (e.g., when the solvent is water), the selected time period is 60 seconds or less, for example 45 seconds or less, and perhaps 30 seconds or less.

Since the solvent 15 is provided in a “sweet spot” amount, it does not substantially degrade a skeleton of the aerogel sheet. As such, when the solvent 15 contacts the aerogel sheet 20, it does not degrade it substantially (preferably not at all) nor does it cause it to become opaque. Further, the contact between the solvent 15 and the aerogel sheet 20 preferably does not cause substantial pore collapse, substantial increase in haze, and/or substantial decrease in thermal conductivity of the aerogel sheet.

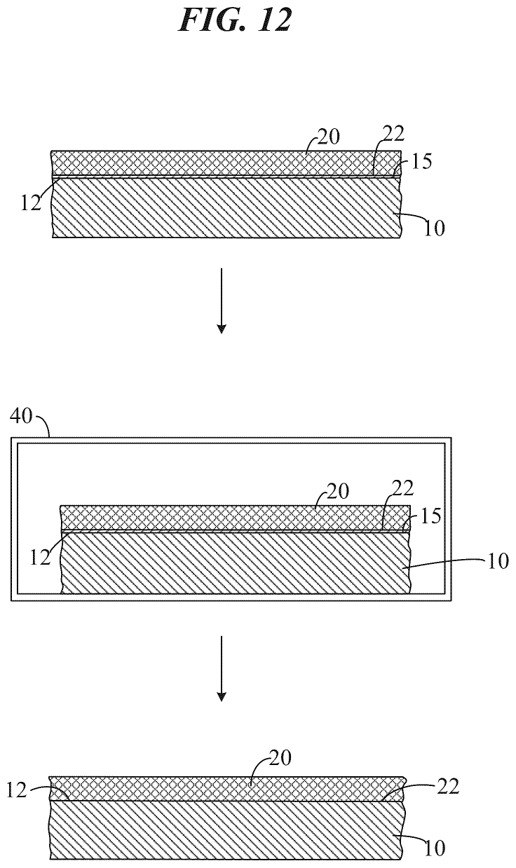

Next, the glass-aerogel article 5 (e.g., with solvent 15 between the major surface 12 and the face 22, and/or in the pores of the aerogel) undergoes drying. Any desired drying process(es) can be allowed or optionally actively performed. This preferably facilitates adhesion of the glass sheet 10 and the aerogel sheet 22. FIGS. 11 and 12 schematically show the drying process. In some cases, as shown in FIG. 11, the drying involves room temperature drying. In certain cases, the room temperature drying takes place at a temperature in a range of from 10° C. to 30° C., for example in a range of from 20° C. to 24° C. In other cases, as shown in FIG. 12, the drying involves heat treating the glass-aerogel article 5 in a furnace 40. In yet other cases, the drying involves room temperature drying followed by heat treating the glass-aerogel article 5, optionally in a furnace 40.

FIG. 12 shows a furnace 40 with a glass-aerogel article 5 inside. The air in the furnace 40 can be maintained at a desired temperature to convert some or all of the liquid solvent to the gaseous state. This preferably facilitates adhesion between the glass sheet 10 and the aerogel sheet 20. In some cases, the heat treating can be carried out with air in the furnace 40 (or other heat treatment equipment) at a temperature of from 100° C. to 300° C., for example at a temperature of from 100° C. to 200° C. Further, the heat-treating in the furnace 40 can be carried out for a desired heating period. In some cases, the desired heating period is greater than 1 hour but less than 3 hours. The desired temperature and heating period can be adjusted as needed to facilitate adhesion.

The drying evaporates at least some solvent 15. In certain cases, the drying evaporates substantially all solvent 15. In specific cases, the drying evaporates at least 90% of the solvent. In further cases, the drying evaporates at least 95% of the solvent.

Without being bound to any scientific theory, it is surmised that during drying, liquid solvent in the pores transitions to gaseous state (e.g., evaporates), thereby creating a vacuum, negative pressure or suction effect at the face 22 of the aerogel sheet 20. This is believed to enhance adhesion between the major surface 12 and the face 22. Additionally, Applicant has surprisingly discovered that this adhesion remains strong even after drying is completed and substantially all solvent is evaporated.

Upon completion of drying, the glass-aerogel article 5 shown in FIG. 1 or 2 remains. In many cases, the glass-aerogel article 5 consists essentially of the glass sheet 10 and the aerogel sheet 20. In some cases, the glass-aerogel article 5 is devoid of an adhesive or primer (e.g., a polymeric primer or a ceramic primer) between the glass sheet and the aerogel sheet. In preferred cases, the glass-aerogel article 5 is devoid entirely of an adhesive or a primer. The glass-aerogel article 5 described herein is particularly useful in an insulating glazing unit, where it may be advantageous not to include an adhesive (e.g., a polymer adhesive), primer or other material that may outgas substantially.

Additionally, after drying is completed, the glass-aerogel article 5 is preferably devoid of permanent marks formed by the solvent 15. In certain cases, the glass-aerogel article 5 is devoid of permanent marks visible to the naked eye. In specific cases, the glass-aerogel article 5 is devoid of permanent marks visible through the shadow imaging technique described in U.S. Patent Application Publication No. 2023/0416099, entitled “Silica Wet Gel and Aerogel Materials,” the contents of which are incorporated herein by reference. This can optionally be the case for any embodiment of the present disclosure.

The glass-aerogel article 5 has an advantageous combination of properties after drying. First, the glass-aerogel article 5 desirably has low haze. For example, the haze can optionally be 5% or less, such as 4% or less, 3% or less, 2.5% or less, 2% or less or 1.75% or less. In some cases, the glass-aerogel article 5 has a haze of from 1.35% to 1.65%. A haze level within any one or more (e.g., all) of these ranges can optionally be provided in any embodiment of the present disclosure. Haze can be measured in well-known fashion, e.g., using a BYK Haze-Gard plus instrument. Reference is made to ASTM D 1003-00: Standard Test method for Haze and Luminous Transmittance of Transparent Plastics, the contents of which are incorporated herein by reference.

The glass-aerogel article 5 desirably also has high visible transmission. In cases where the glass-aerogel article 5 does not include a coating between the glass sheet 10 and the aerogel sheet 20 (e.g., as shown in FIG. 1), the glass-aerogel article 5 has a visible transmission of at least 95%, for example at least 97.8%, at least 97.9%, at least 98%, at least 98.1%, at least 98.2%, at least 98.3%, at least 98.4%, at least 98.5%, at least 98.6%, at least 98.7%, at least 98.8%, at least 98.9%, at least 99%, such as at least 99.1%, at least 99.2%, at least 99.3%, at least 99.4%, or perhaps at least 99.5%. In cases where the glass-aerogel article 5 includes a low-emissivity coating between the glass sheet 10 and the aerogel sheet 20 (e.g., as shown in FIG. 2), the glass-aerogel article 5 can have a visible transmission of at least 30%, such as from 30 to 80%. Furthermore, any of the above-noted haze levels can optionally be provided, together with any transmission range noted in this paragraph, for any embodiment of this disclosure.

The term “visible transmission” is well known in the art and is used herein in accordance with its well-known meaning to refer to the percentage of all incident visible radiation that is transmitted through an object (e.g., through the aerogel sheet, or through the glass-aerogel article). Visible radiation constitutes the wavelength range of from about 380 nm to about 780 nm. Visible transmission can be determined in accordance with NFRC 300-2017, Standard Test Method for Determining the Solar and Infrared Optical Properties of Glazing Materials and Fading Resistance of Systems. The well-known and commercially available LBNL WINDOW 7.4 computer program can be used in calculating these and other reported optical properties. The glass-aerogel article 5, in any embodiment of this disclosure, can advantageously have both haze and visible transmission properties in any combination of the above-noted ranges for haze and visible transmission, optionally together with the above-noted shadow imaging results.

The glass-aerogel article 5 can optionally also have desirable transmitted color characterized by “a” and “b” color coordinates that are each between −2 and 2. The present discussion of color properties is reported using the well-known color coordinates of “a” and “b.” In more detail, the color coordinates are indicated herein using the subscript h (i.e., ah and bh) to represent the conventional use of the well-known Hunter Lab Color System (Hunter methods/units, Ill. D65, 10 degree observer). The present color properties can be calculated as specified in “Insight on Color,” “Hunter L, a, b Color Scale,” Applications Note, Vol. 8, No. 9, June 2008 (2008), the relevant teachings of which are incorporated herein by reference.

In addition, the aerogel sheet 20 can have a low bulk density. In certain embodiments, the aerogel sheet 20 has a bulk density of 200 mg/cc or less. In some cases, the aerogel sheet 20 has a bulk density of 150 mg/cc or less, such as 140 mg/cc or less, 130 mg/cc or less, or 125 mg/cc or less. In certain embodiments, the aerogel sheet 20 also has a bulk density of at least 70 mg/cc. In some cases, the aerogel sheet has a bulk density of at least 80 mg/cc, such as at least 85 mg/cc, or at least 95 mg/cc. In preferred embodiments, the aerogel sheet 20 has a bulk density of from 100 mg/cc to 150 mg/cc, such as from 120 mg/cc to 150 mg/cc. In certain cases, the bulk density is 120 mg/cc. The density of the aerogel sheet 20 can optionally be in one or more (optionally all) of the foregoing ranges for any embodiment of the present disclosure, preferably in combination with the glass-aerogel article 5 having a visible transmission and haze levels in any combination of the ranges noted above (e.g., Tis of at least 97.8%, at least 98%, at least 98.6% or at least 99%, together with a haze of 3% or less, 2% or less, 1.75% or less, or 1.5% or less). Bulk density can be determined by weighing the aerogel sheet 20 and then calculating the volume using the dimensions of the aerogel sheet.

The aerogel sheet 20 can also have low thermal conductivity. For example, the aerogel sheet 20 can have a thermal conductivity of 14 mW/m*K or less in air, such as 13.5 mW/m*K or less, 13 mW/m*K or less, 12 mW/m*K or less, or 11.5 mW/m*K or less. Furthermore, the aerogel sheet 20 can have a thermal conductivity of 10 mW/m*K or less in an inert gas, such as argon. The thermal conductivity of the aerogel sheet 20 can optionally be in one or more (optionally all) of these ranges for any embodiment of the present disclosure. Thermal conductivity can be determined using a conventional heat flow meter, such as the well-known TA Instruments Fox 200 heat flow meter, which is commercially available from Waters Corporation (New Castle, Delaware, U.S.A.).

Further, the aerogel sheet 20 can have a flexural modulus of 6000 kPa or less, such as 4500 kPa or less, 2400 kPa or less, 2300 kPa or less, 2000 kPa or less, 1900 kPa or less, 1800 kPa or less, 1700 kPa or less, 1600 kPa or less, 1500 kPa or less, 1400 kPa or less, 1300 kPa or less, 1200 kPa or less, 1100 kPa or less, 1000 kPa or less, 900 kPa or less, 800 kPa or less, 750 kPa or less, or even 700 kPa or less. In some cases, the aerogel sheet 20 can have a flexural modulus of from 700 kPa to 6000 kPa, such as from 750 kPa to 6000 kPa, from 800 kPa to 6000 kPa, from 900 kPa to 6000 kPa, from 1000 kPa to 6000 kPa, from 1100 kPa to 6000 kPa, from 1200 kPa to 6000 kPa, from 1300 kPa to 6000 kPa, from 1400 kPa to 6000 kPa, from 1500 kPa to 6000 kPa, from 1600 kPa to 6000 kPa, from 1700 kPa to 6000 kPa, from 1800 kPa to 6000 kPa, from 1900 kPa to 6000 kPa, from 2000 kPa to 6000 kPa, from 2300 kPa to 6000 kPa or from 2400 kPa to 6000 kPa.

The flexural modulus of a material is a mechanical property that measures the material's stiffness or resistance to bending, and is defined as the ratio of stress to strain in flexural deformation. It is determined from the slope of a stress-strain curve produced by a flexural test, such as ASTM D790: Standard Test Methods for Flexural Properties of Unreinforced and Reinforced Plastics and Electrical Insulating Material, the contents of which are incorporated herein by reference. The higher the flexural modulus of a material, the harder it is to bend. Conversely, the lower the flexural modulus, the easier it is for the material to bend under an applied force.

The aerogel sheet 20 can have an average pore size of 31 nm or less, such as 30 nm or less, 29 nm or less, 28 nm or less, 27 nm or less, 26 nm or less, 25 nm or less, 24 nm or less, 23 nm or less, 22 nm or less, 21 nm or less, or even 20 nm or less. The average pore size can be determined using a Quantachrome “autosorb-iQ” gas absorption analyzer, which is commercially available from Anton Paar (Graz, Austria) along with calculating average pore size using density functional theory (DFT) calculations.

The aerogel sheet 20 can also have a specific surface area of at least 750 m²/g, such as at least 800 m²/g, at least 850 m²/g, at least 900 m²/g, at least 950 m²/g, or at least 1000 m²/g. The aerogel sheet 20 can optionally have this specific surface area in combination with an average pore size in one or more (optionally all) of the ranges noted in the paragraph above and/or in combination with a density of from 100 mg/cc to 150 mg/cc, optionally in further combination with the glass-aerogel article 5 having visible transmission and haze levels in any combination of the ranges noted above (e.g., Tis of at least 97.8%, perhaps at least 98%, at least 98.6%, or at least 99%, together with haze of 3% or less, 2% or less, 1.75% or less, or 1.5% or less). The specific surface area can be determined using a Quantachrome “autosorb-iQ” gas absorption analyzer, which is commercially available from Anton Paar (Graz, Austria) along with calculating specific surface area using density functional theory (DFT) calculations.

### EXAMPLES

Exemplary glass-aerogel articles (Examples #1-#3) were prepared and assessed for adhesive strength and for visual defects. Results obtained for these examples are tabulated in Table 1.

### Example #1

Example #1 was prepared according to the following steps:
A. Providing a silica aerogel sheet having dimensions of 5 inches by 5 inches. The silica aerogel sheet was prepared according to the following steps:
   i. Preparing a first solution by mixing 360 mL methanol and 140 mL MS-51. The first solution included methanol at a volume percent of 72% and MS-51 at a volume percent of 28%.
   ii. Preparing a second solution by mixing 360 mL methanol, 139.02 mL water and 0.98 mL ammonium hydroxide solution. The ammonium hydroxide solution included water at a volume percent of 99.3% and 0.7 ammonium hydroxide catalyst concentration. The second solution included methanol at a volume percent of 78%, water at a volume percent of 27.8%, and ammonium hydroxide at a volume percent of 0.2%.
   iii. Mixing the 30 mL of the first solution and 30 mL of the second solution together to form a mixed solution.
   iv. Depositing 59.15 mL of the mixed solution in a mold having interior dimensions of 130 mm by 130 mm by 3.5 mm. Sealing the mold to provide an airtight environment.
   v. Allowing components in the mixed solution to react to form silica wet gel sheet having dimensions of 130 mm by 130 mm by 3.5 mm.
   vi. Aging the silica wet gel sheet in the mold at room temperature for a time period of at least 240 hours.
   vii. Removing the silica wet gel sheet from the mold.
   viii. Cutting the silica wet gel sheet to have dimensions of 5 inch by 5 inch by 3.5 mm.
   ix. Placing the silica wet gel sheet in a first methanol bath and allowing solvent exchange to take place for 8 hours.
   x. Placing the silica wet gel sheet in a second methanol bath and allowing solvent exchange to take place for 8 more hours.
   xi. Placing the silica wet gel sheet in a dryer and performing critical point drying with a complete CO₂ exchange to obtain a silica aerogel sheet.
   xii. Placing the silica aerogel sheet in a Quincy Lab 30 GC oven and heating the silica aerogel sheet at an internal temperature set to 150° C. for a time period of one hour.
B. Assessing the presence of visual defects on the silica aerogel sheet using shadow imaging methods described herein.
C. Providing a LoE3-366® glass sheet, obtained from Cardinal CG Company, having dimensions of 6 inches by 6 inches. The glass sheet includes a low-emissivity coating on one surface and no coating on the opposite surface.
D. Wiping down the glass sheet with a Technicloth® Texwipe TX 609 containing Windex® Glass Cleaner.
E. Using compressed air to remove any dust particles from the glass sheet.
F. Treating the glass sheet in an Espec Chamber having an internal temperature set to 25° C. and containing water vapor at a relative humidity level of 50% for a time period of 10 minutes. Ensure that the surface of the glass sheet bearing the low-emissivity coating faces upward and is exposed to the water vapor.
G. Positioning the surface of the glass sheet bearing the low-emissivity coating onto a surface of the silica aerogel sheet to form a glass-aerogel article. The positioning is performed within 45 seconds of removing the glass sheet from the Espec Chamber.
H. Allowing the glass-aerogel article to dry at room temperature.
I. Assessing presence of visual defects on the silica aerogel sheet of the glass-aerogel article using shadow imaging described herein. Comparing results obtained in step B to results obtained in step I to determine if significant variation in visual defects was observed after steps C-H were performed. If no significant variation was observed, such that there were not visual defects at steps B or I, designating the presence of visual defects as “none.”
J. Assessing adhesive strength between the silica aerogel sheet and glass sheet of the glass-aerogel article by spraying gas from a DUST-OFF Aerosol Duster, manufactured by Falcon Safety Products, towards the silica aerogel sheet at varying pressures and varying angles. If any portion of the silica aerogel sheet remained on the glass sheet, classifying the adhesive strength as strong. If none of the silica aerogel sheet remained on the glass sheet, classifying the adhesive strength as weak.

Results obtained from Example #1 are shown in Table #1.

### Example #2

Example #2 was prepared by repeating steps A-E and G-J as performed in Example #1. Step F was performed according to the following steps:
i. Heating the glass sheet in a Quincy Lab 30 GC oven having an internal temperature set to 150° C. for a time period of 3 minutes.
ii. Applying water vapor from a Pionix 1000W handheld garment steamer to the surface of the glass sheet that bears the low-emissivity coating. The steamer is held at approximately 8 inches from the surface and applied until fogging is visible on the surface.
   Additionally, step G is performed within 45 seconds of applying steam. Results obtained from Example #2 are shown in Table #1.

### Example #3

Example #3 was prepared by repeating steps A-E and G-J as performed in Example #1. Step F was performed according to the following steps:
i. Heating the glass sheet in a Quincy Lab 30 GC oven having an internal temperature set to 150° C. for a time period of 3 minutes.
ii. Spraying methanol (99.9% anhydrous methanol) from a Framar Myst Assist spray bottle to the surface of the glass sheet that bears the low-emissivity coating. The spray bottle is held 1 inch in front of, and 5 inches above, the surface and continuously pumped to spray for a time period of 10 seconds.
Further, step G is performed within 45 seconds of spraying. Results obtained from Example #3 are shown in Table #1.

TABLE #1

| | Example #1 | Example #2 | Example #3 |
|---|---|---|---|
| Solvent | Water | Water | Methanol |
| Solvent State on | Droplets | Droplets | Droplets |
| Glass Surface | | | |
| Adhesive Strength | Strong | Strong | Strong |
| Visual Defects | None | None | None |

The glass-aerogel article 5 formed by methods described herein can be provided as part of (e.g., incorporated into) another structure. In some embodiments, the glass-aerogel article 5 is provided (e.g., assembled together) as part of an insulating glazing unit. For example, the glass-aerogel article 5 can comprise a pane of an insulating glazing unit (i.e., the glass sheet 10 of the glass-aerogel article 5 can serve as one pane of an insulating glazing unit 45).

FIGS. 13 and 14 show embodiments of an insulating glazing unit 45 that incorporates a glass-aerogel article 5 described herein. The insulating glazing unit 45 includes an outboard pane 600 and an inboard pane 605. The outboard pane 600 defines a #1 surface and a #2 surface. The inboard pane 605 defines a #3 surface and a #4 surface. The insulating glazing unit 45 can optionally be mounted in a frame such that the #1 surface is exposed to an outdoor environment, while the #4 surface is exposed to an indoor environment (e.g., an environment inside a building).

The glass-aerogel article 5 can comprise either the outboard pane 600 or the inboard pane 605. In FIG. 13, the glass-aerogel article 5 comprises the inboard pane 605. In FIG. 14, the glass-aerogel article comprises the outboard pane 600. If desired, there can be a first glass-aerogel article comprising an outboard pane and a second glass-aerogel article comprising an inboard pane.

Thus, FIG. 13 illustrates an insulating glazing unit 45 having a glass-aerogel article 5 comprising an inboard pane 605. The illustrated inboard pane 605 comprises a glass sheet 10 having a major surface 12 that defines the #3 surface and an opposing major surface 14 that defines the #4 surface. The major surface 12 has an aerogel sheet 20 adhered thereto and faces a between-pane space 50. The major surface 14 is shown facing an indoor environment. An optional transparent conductive oxide coating 85 can be provided on the major surface 14 (i.e., the #4 surface). The transparent conductive oxide coating 85 can be of any type, such as those described herein.

The outboard pane 600 of the insulating glazing unit 45 shown in FIG. 13 comprises a glass sheet 100 having a major surface 112 that defines the #2 surface and an opposing major surface 114 that defines the #1 surface. The major surface 112 faces the between-pane space 50 and defines the #2 surface. The major surface 114 is shown facing an outdoor environment and defines a #1 surface. An optional low-emissivity coating 70 can be provided on the major surface 112 (i.e., the #2 surface). The low-emissivity coating 70 can be of any type, such as those described herein.

FIG. 14 illustrates an insulating glazing unit 45 having a glass-aerogel article 5 comprising an outboard pane 600. The outboard pane comprises a glass sheet 10 having a major surface 12 that defines the #2 surface and an opposite major surface 14 that defines the #1 surface. The major surface 12 has an aerogel sheet 20 adhered thereto and faces a between-pane space 50. The major surface 14 is shown facing an outdoor environment. An optional low-emissivity coating 70 can be provided on the major surface 12 such that it is between the glass sheet 10 and the aerogel sheet 20. Here too, the low-emissivity coating 70 can be of any type, such as those described herein.

The inboard pane 605 of the insulating glazing unit 45 shown in FIG. 14 comprises another glass sheet 100 having a major surface 112 that defines the #3 surface and an opposing major surface 114 that defines the #4 surface. The major surface 112 faces a between-pane space 50. The major surface 114 is shown facing an indoor environment and defines a #4 surface. Here too, an optional transparent conductive coating 85 can be provided on the major surface 114 (i.e., the #4 surface) and can be of any type, such as those described herein.

The panes 600, 605 can have any of the features, compositions, and dimensions described for a glass sheet 10 elsewhere herein. In alternative embodiments, one or both panes 600, 605 are replaced with sheets formed of a polymer, such as polycarbonate. The aerogel sheet 20 can also have any of the features and properties described elsewhere herein.

The between-pane space 50 is located between the two panes 600, 605. In certain embodiments, the between-pane space 50 contains a gaseous atmosphere, preferably comprising a thermally insulative gas, such as argon, krypton, or both. In some cases, the gaseous atmosphere comprises a mix of argon and air (e.g., 90% argon and 10% air). In other cases, the gaseous atmosphere comprises a mix of krypton and air. In still other cases, the gaseous atmosphere comprises a mix of argon, krypton, and air. In yet other cases, the gaseous atmosphere is just air. If desired, the between-pane space can be evacuated to a desired extent.

In certain cases, a gas gap G is provided in the between-pane space 50 alongside the aerogel sheet 20. In some cases, the gas gap G has a width in a range of from 9 to 14 mm and it contains a gaseous atmosphere comprising argon, air, or both. In certain cases, the between-pane space has a width W in a range of from 14 to 21 mm, the gaseous atmosphere comprises argon, and the width of the gas gap G is from 10.5 to 13.5 mm. Reference is made to U.S. patent application Ser. No. 17/389,603, the teachings of which relating to gas gap and between-pane space configurations are hereby incorporated by reference.

Certain embodiments include a spacer 60 between the two panes 600, 605. The spacer 60 may be a conventional metal channel spacer, e.g., formed of stainless steel or aluminum. Or it can comprise polymer and metal, or just polymer (e.g., foam). The spacer can alternatively be an integral part of a sash, frame, etc. so as to maintain the IG unit in the desired configuration.

When provided, the spacer 60 can be adhered to the panes 600, 605 by one or more beads of sealant, as is conventional and well-known to skilled artisans. In FIGS. 13 and 14, the spacer 60 is shown with a primary sealant 55 on opposite sides of the spacer 60 and a secondary sealant 58 provided on an outside wall of the spacer 60. Another option is to omit the secondary sealant and provide a single deposit of sealant along both sides of the spacer and on the outside wall of the spacer. Various other known sealant arrangements/systems can alternatively be used. In other cases, the spacer may be omitted while one or more beads of sealant (optionally together with a moisture vapor barrier) are provided about the perimeter of the unit so as to encompass the aerogel sheet 20.

In some embodiments, the aerogel sheet 20 does not contact the spacer 60. For example, the aerogel sheet 20 may be separated (i.e., spaced apart) from the spacer 60 by 1 mm to 5 mm (e.g., 2-4 mm, such as about 3 mm). When provided, the sealant 55, 58 between the spacer 60 and the two adjacent panes 600, 605 can also be spaced from the aerogel sheet 20.

While FIGS. 13 and 14 show a double-pane insulating glazing unit, other embodiments provide a triple-pane insulating glazing unit having a glass-aerogel article 5 incorporated therein. The glass-aerogel article 5 can comprise any pane. If desired, a first glass-aerogel article can comprise a first pane, while a second glass-aerogel article can comprise a second or third pane. Thus, an aerogel sheet 20 of the glass-aerogel article 5 can be on the #2 surface or the #3 surface. For triple-pane insulating glazing units, an aerogel sheet 20 of the glass-aerogel article 5 can be on the #2 surface, the #3 surface, the #4 surface, or the #5 surface.

The aerogel sheet 20 has a thickness AT. In some embodiments, the aerogel sheet 20 has a thickness AT in a range of from 1.5 mm to 15 mm, such as from 2 mm to 8 mm, or from 2 mm to 4 mm (e.g., about 3 mm) or from 3 mm to 5 mm (e.g., about 4 mm). It is to be appreciated, however, that other thicknesses can be used.

The between-pane space 50 has a thickness W, which is measured from the interior surface 12 of glass sheet 10 to the interior surface 112 of glass sheet 100. In certain embodiments, the aerogel sheet 20 does not occupy the entire thickness W of the between-pane space 50. In other cases, the aerogel sheet 20 occupies the entire thickness of the between-pane space.

A ratio of the thickness AT of the aerogel sheet 20 to the thickness W of the between-pane space 50 preferably is from 0.15 to 0.85. In some embodiments, the thickness W of the between-pane space 50 is at least 10 mm, optionally together with the thickness AT of the aerogel sheet 20 being from 2 mm to 8 mm. In certain preferred embodiments, the aerogel sheet 20 occupies 50% or less of the thickness W of the between-pane space 50 (e.g., 45% or less, 40% or less, or 35% or less of the thickness W of the between-pane space 50).

In other embodiments, the aerogel sheet 20 occupies a majority of the thickness W of the between-pane space 50. In such instances, the thickness AT of the aerogel sheet 20 preferably is from 8 mm to 15 mm (e.g., about 10 mm), while the thickness of the gas gap G alongside the aerogel sheet 20 is optionally 5 mm or less (e.g., about 3 mm).

Certain embodiments provide an insulating glazing unit 45 that includes an optional transparent conductive oxide coating 85. The transparent conductive oxide coating 85 can be provided on any desired surface. In some cases, the transparent conductive oxide coating 85 is provided on a major surface 14 of a glass sheet 10 that forms part of the glass-aerogel article 5 described herein. For example, the transparent conductive oxide coating 85 can be provided on a major surface 14 opposite the major surface 12 that is adhered to the aerogel sheet 20. In other cases, the transparent conductive oxide coating 85 is provided on a surface of a glass sheet that is not part of the glass-aerogel article 5.

In the embodiment of FIG. 13, an optional transparent conductive oxide coating 85 is provided on the exterior surface 14 of the glass sheet 10. In the embodiment of FIG. 14, an optional transparent conductive oxide coating 85 is provided on an exterior surface 114 of a glass sheet 100. The optional transparent conductive oxide coating 85 can be provided on other surfaces also, if desired. In the embodiments of FIGS. 13 and 14, the illustrated transparent conductive oxide coating 85 can optionally be omitted.

When provided, the optional transparent conductive oxide coating 85 can include indium tin oxide. In alternate embodiments, zinc aluminum oxide, SnO:Sb, SnO:F, or another known transparent conductive oxide is used. In some cases, transparent conductive oxide coating 85 comprises tin oxide together with antimony, fluorine, or another dopant. Further, in some cases, the transparent conductive oxide coating 85 is a sputtered film. In other embodiments, the transparent conductive oxide coating 85 comprises a pyrolytic film that includes tin (e.g., comprising tin oxide together with antimony, fluorine, or another dopant). Also, in some cases, the transparent conductive oxide coating 85 includes carbon nanotubes.

When provided, the transparent conductive oxide coating 85 preferably is provided at a thickness of 10,000 Å or less, such as from about 1,000 Å to about 7,000 Å, e.g., from 1,000 Å to 1,750 Å, such as from 1,300 to 1,600 Å. For any embodiment where the transparent conductive oxide coating 85 is provided, it can optionally comprise a transparent conductive oxide film having a thickness of from 1,000 Å to 1,750 Å.

The transparent conductive oxide coating 85 can, for example, be a coating of the type described in any of U.S. Pat. No. 9,862,640 or 10,000,965 or 10,000,411 or 11,155,493, the teachings of which concerning the transparent conductive oxide coating are hereby incorporated herein by reference.

In some cases, the insulating glazing unit 45 includes both a transparent conductive oxide coating 85 and a low-emissivity coating 70. This, however, is by no means required. For example, in some cases, the insulating glazing unit 45 includes the low-emissivity coating 70 but is devoid of the transparent conductive oxide coating 85. This can optionally be the case for the embodiments shown in FIGS. 13 and 14.

Other embodiments provide a method of making an insulating glazing unit. The method comprises forming a glass-aerogel article 5 according to any method described herein, and assembling the glass-aerogel article 5 together with one or more additional glass sheets in forming the insulating glazing unit.

Certain embodiments provide a laminated glass assembly that incorporates a glass-aerogel article 5. FIGS. 15 and 16 illustrate a laminated glass assembly 80 comprising a first glass sheet 10 and a second glass sheet 100. The glass-aerogel article 5 comprises the first glass sheet 10. In some embodiments, the laminated glass assembly 80 also includes a spacer. In other cases, the spacer is omitted and the laminated glass assembly 80 just has one or more beads of sealant 58 (optionally together with a foil moisture barrier, tape, or both) at the perimeter of the assembly.

The glass-aerogel article 5 can be formed according to any process described herein and can have any of the features and properties discussed herein. The laminated glass assembly 80 can also include a polymer interlayer 400. When provided, the polymer interlayer 400 preferably is a tear-resistant polymer layer. In some cases, it is a sheet of ionoplast plastic, which is commercially available from Kuraray America, Inc. (Houston, Texas, U.S.A.). For laminated embodiments, any ionoplast or other interlayer material that may be used should be compatible with the aerogel. In certain embodiments, both glass sheets 10, 100 are clear 3 mm soda-lime float glass. It is to be appreciated, however, that these details are by no means limiting.

FIG. 15 shows an embodiment having a single polymer interlayer 400. In other embodiments, there are two polymer interlayers. In such embodiments, the aerogel sheet is sandwiched between, and laminated to, the two polymer interlayers. In still other embodiments, the polymer interlayer(s) are omitted, and the aerogel sheet 20 replaces the interlayer(s). FIG. 16 shows an embodiment with the polymer interlayer(s) omitted.

Other embodiments provide a method of making a laminated glass assembly. Here too, the method comprises forming a glass-aerogel article 5 according to any method described herein and assembling the glass-aerogel article 5 together with an additional glass sheet 100 in forming the laminated glass assembly. The glass-aerogel article 5, additional glass sheet 100, and one or more optional polymer interlayers 400 can be assembled together as part of a laminated glass assembly using any suitable techniques. The lamination process may include various known autoclave glass lamination techniques. In some other cases, the process may include one or more steps described in U.S. Pat. Nos. 7,117,914 and 7,143,800, the teachings of which concerning non-autoclave glass lamination are incorporated herein by reference.

While some preferred embodiments of the invention have been described, it should be understood that various changes, adaptations and modifications may be made therein without departing from the spirit of the invention and the scope of the appended claims.

What is claimed is:

1. A method of making an article, comprising:
providing a solvent on a major surface of a glass sheet, and
positioning a face of an aerogel sheet onto the major surface of the glass sheet to create a glass-aerogel article, such that the solvent on the major surface of the glass sheet facilitates adhesion of the aerogel sheet to the glass sheet.

2. The method of claim 1 wherein an entirety of the aerogel sheet is transparent both before and after said positioning the face of the aerogel sheet onto the major surface of the glass sheet to create the glass-aerogel article.

3. The method of claim 2 wherein the aerogel sheet contacts the solvent on the major surface of the glass sheet during said positioning the face of the aerogel sheet onto the major surface of the glass sheet to create the glass-aerogel article, yet said contact between the aerogel sheet and the solvent does not cause the aerogel sheet to become opaque.

4. The method of claim 1 wherein the solvent comprises a material selected from the group consisting of water, methanol, acetone, N-hexane, ethanol, and isopropyl alcohol.

5. The method of claim 1 wherein the solvent comprises water.

6. The method of claim 1 wherein the aerogel sheet is a hydrophilic aerogel sheet.

7. The method of claim 1 wherein the aerogel sheet is synthesized from methyl silicate 51.

8. The method of claim 1 wherein the aerogel sheet is synthesized from TMOS.

9. The method of claim 1 wherein said providing the solvent comprises exposing the glass sheet to the solvent in a gaseous state such that the solvent transitions from the gaseous state to a liquid state and thereby deposits in the liquid state on the major surface of the glass sheet.

10. The method of claim 1 wherein said providing the solvent comprises spraying the solvent onto the major surface of the glass sheet.

11. The method of claim 10 further comprising heating the glass sheet such that it is above room temperature during said spraying the solvent onto the major surface of the glass sheet.

12. The method of claim 1 wherein said providing solvent on the major surface of the glass sheet creates substantially uniform coverage of solvent over the major surface of the glass sheet.

13. The method of claim 1 further comprising flowing gas toward the aerogel sheet during said positioning the face of the aerogel sheet onto the major surface of the glass sheet to create the glass-aerogel article, thereby creating a gas pressure that facilitates the adhesion of the aerogel sheet to the glass sheet.

14. The method of claim 1 further comprising drying the glass-aerogel article to evaporate at least some of the solvent and to facilitate the adhesion of the aerogel sheet to the glass sheet.

15. The method of claim 14 wherein said drying the glass-aerogel article evaporates at least 90% of the solvent.

16. The method of claim 14 wherein, after said drying, the glass-aerogel article consists essentially of the glass sheet and the aerogel sheet.

17. The method of claim 14 wherein, after said drying, the glass-aerogel article has a haze value of less than 5%.

18. The method of claim 14 wherein, after said drying, the glass-aerogel article has a visible transmission of 95% or more.

19. The method of claim 14 wherein the major surface of the glass sheet bears a low-emissivity coating comprising one or more infrared-reflective films comprising silver, such that the glass-aerogel article includes the low-emissivity coating between the glass sheet and the aerogel sheet.

20. The method of claim 1 wherein there is neither a polymeric primer nor a ceramic primer between the glass sheet and the aerogel sheet of the glass-aerogel article.

21. A method of making an article, comprising:
providing water on a major surface of a glass sheet, and
positioning a face of a hydrophilic aerogel sheet onto the major surface of the glass sheet to create a glass-aerogel article, such that the water on the major surface of the glass sheet facilitates adhesion of the hydrophilic aerogel sheet to the glass sheet.

22. The method of claim 21 wherein an entirety of the hydrophilic aerogel sheet is transparent both before and after said positioning the face of the hydrophilic aerogel sheet onto the major surface of the glass sheet to create the glass-aerogel article.

23. The method of claim 22 wherein the hydrophilic aerogel sheet contacts the water on the major surface of the glass sheet during said positioning the face of the hydrophilic aerogel sheet onto the major surface of the glass sheet to create the glass-aerogel article, yet said contact between the hydrophilic aerogel sheet and the water does not cause the hydrophilic aerogel sheet to become opaque.

24. The method of claim 21 wherein the hydrophilic aerogel sheet is a hydrophilic silica aerogel sheet synthesized from methyl silicate 51.

25. The method of claim 21 wherein the hydrophilic aerogel sheet is a hydrophilic silica aerogel sheet synthesized from TMOS.

26. The method of claim 21 wherein said providing water comprises exposing the major surface of the glass sheet to a high humidity environment, the high humidity environment having a relative humidity of 45% or greater.

27. The method of claim 26 further comprising heating the glass sheet such that it is above room temperature during said exposing the major surface of the glass sheet to the high humidity environment.

28. The method of claim 21 wherein said providing water comprises spraying water onto the major surface of the glass sheet.

29. The method of claim 28 wherein said spraying water onto the major surface of the glass sheet is performed such that the major surface of the glass sheet becomes fogged yet has no visible water droplets.

30. The method of claim 29 wherein said spraying water onto the major surface of the glass sheet is performed such that the major surface of the glass sheet becomes fogged yet has no water clusters larger than 5.88 nm.

31. The method of claim 28 further comprising heating the glass sheet such that it is above room temperature during said spraying water onto the major surface of the glass sheet.

32. The method of claim 21 wherein said providing water on the major surface of the glass sheet creates substantially uniform coverage of water over the major surface of the glass sheet.

33. The method of claim 21 wherein, during said positioning the face of the hydrophilic aerogel sheet onto the major surface of the glass sheet, there is water on the major surface of the glass sheet, such that the hydrophilic aerogel sheet contacts the water.

34. The method of claim 33 wherein said contact between the hydrophilic aerogel sheet and the water creates substantially no increase in haze of the aerogel sheet.

35. The method of claim 33 wherein said contact between the hydrophilic aerogel sheet and the water creates substantially no decrease in thermal conductivity of the aerogel sheet.

36. The method of claim 21 further comprising flowing gas toward the hydrophilic aerogel sheet during said positioning the face of the hydrophilic aerogel sheet onto the major surface of the glass sheet to create the glass-aerogel article, thereby creating a gas pressure that facilitates the adhesion of the hydrophilic aerogel sheet to the glass sheet.

37. The method of claim 21 further comprising drying the glass-aerogel article to evaporate at least some of the water and to facilitate the adhesion of the hydrophilic aerogel sheet to the glass sheet.

38. The method of claim 37 wherein said drying the glass-aerogel article evaporates at least 90% of the water.

39. The method of claim 37 wherein, after said drying, the glass-aerogel article consists essentially of the glass sheet and the aerogel sheet.

40. The method of claim 37 wherein, after said drying, the glass-aerogel article has a haze value of less than 5%.

41. The method of claim 37 wherein, after said drying, the glass-aerogel article has a visible transmission of 95% or more.

42. The method of claim 37 wherein the major surface of the glass sheet bears a low-emissivity coating comprising one or more infrared-reflective films comprising silver, such that the glass-aerogel article includes the low-emissivity coating between the glass sheet and the aerogel sheet.

43. The method of claim 21 wherein there is neither a polymeric primer nor a ceramic primer between the glass sheet and the hydrophilic aerogel sheet of the glass-aerogel article.
